(19) United States
(12) Patent Application Publication
(10) Pub. No.: US 2019/0095069 A1
(43) Pub. Date: Mar. 28, 2019

(54) ADAPTABLE INTERFACE FOR RETRIEVING AVAILABLE ELECTRONIC DIGITAL ASSISTANT SERVICES

(71) Applicant: MOTOROLA SOLUTIONS, INC, Chicago, IL (US)

(72) Inventors: LEE PROCTOR, CARY, IL (US); BENJAMIN ZASLOW, CHICAGO, IL (US); ERIC JOHNSON, CHICAGO, IL (US)

(21) Appl. No.: 15/714,214

(22) Filed: Sep. 25, 2017

(51) Int. Cl. G06F 3/0488; G06F 3/0481; H04W 4/22; H04M 3/51

(52) U.S. Cl. CPC G06F 3/0488; H04M 3/5116; H04W 4/22; G06F 3/04812

(57) ABSTRACT

An adaptable interface for retrieving available electronic digital assistant services is provided. A user interface including a graphical underlay on which user input gestures may be operated is displayed via a display element. A particular user input gesture selecting a sub-portion of the graphical underlay is detected. The selected sub-portion of the graphical underlay, or metadata associated therewith, is provided to an electronic digital assistant services query identification function. Identities of one or more available electronic digital assistant services that may be performed on objects or information included in the selected sub-portion of the graphical underlay or metadata associated therewith are received. And one or more actionable user interface elements are displayed on, over, or adjacent to the graphical underlay corresponding to the received identities of the one or more available electronic digital assistant services.

### BACKGROUND OF THE INVENTION

Tablets, laptops, phones (e.g., cellular or satellite), mobile (vehicular) or portable (personal) two-way radios, and other communication devices are now in common use by users, such as first responders (including firefighters, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for operating an electronic digital assistant query services identification function, in accordance with some embodiments.

FIG. 2 is a device diagram showing a device structure of an electronic computing device for operating an electronic digital assistant query function, in accordance with some embodiments.

FIG. 3 illustrates a flowchart setting forth process steps for operating an electronic digital assistant query services identification function, in accordance with some embodiments.

FIG. 4 illustrates an example user interface for operating an electronic digital assistant query services identification function, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In addition to voice input, electronic digital assistants may receive other types of input, including graphical and/or textual, execute some search or query function associated with the underlying graphical and/or textual input provided, and provide an output of additional information relevant to the graphical and/or textual input provided that may provide a user, such as an officer or other type of first responder or user, intelligent and context-specific useful information relevant to their graphical or textual input query. However, problems exist in that such input queries are difficult for a user to generate, and the user may or may not know what types of electronic digital assistant services or databases are available against which to search the underlying graphical and/or textual input. Conventionally, a user may spend an inordinate amount of time identifying a correct service and/or database, identifying its location, and generating a correctly formatted query and providing the query to the correct service or database.

Thus, there exists a need for an improved technical method, device, and system for an electronic digital assistant query services identification function that can take graphical and/or textual input and identify which electronic digital assistant services are available to be performed on the graphical and/or textual input, and thus allow a user such as a first responder to more easily and quickly sub-select particular electronic digital assistant services relative to selected graphical and/or textual input.

In one embodiment, a process at an electronic computing device for providing an adaptable interface for retrieving available electronic digital assistant services includes: displaying, by the electronic computing device via a display element communicatively coupled to the electronic computing device, a user interface including a graphical underlay on which user input gestures may be operated; detecting, by the electronic computing device via an input mechanism by which user input gestures may be detected, a particular user input gesture selecting a sub-portion of the graphical underlay; providing, by the electronic computing device, the selected sub-portion of the graphical underlay or metadata associated therewith, to an electronic digital assistant services query identification function; receiving, at the electronic computing device from the electronic digital assistant services query identification function, identities of one or more available electronic digital assistant services that may be performed on objects or information included in the selected sub-portion of the graphical underlay or metadata associated therewith; and displaying, by the electronic computing device via the display element, one or more actionable user interface elements on, over, or adjacent to the graphical underlay corresponding to the received identities of the one or more available electronic digital assistant services.

In a further embodiment, an electronic computing device implementing an adaptable interface for retrieving available electronic digital assistant services includes: a memory storing non-transitory computer-readable instructions; a transceiver; a display element; an input mechanism by which user input gestures may be detected; and one or more processors configured to, in response to executing the non-transitory computer-readable instructions, perform a first set of functions comprising: display, via the display element, a user interface including a graphical underlay on which user input gestures may be operated; detect, via the input mechanism, a particular user input gesture selecting a sub-portion of the graphical underlay; provide the selected sub-portion of the graphical underlay or metadata associated therewith to an electronic digital assistant services query identification function; receive, from the electronic digital assistant services query identification function, identities of one or more available electronic digital assistant services that may be performed on objects or information included in the selected sub-portion of the graphical underlay or metadata associated therewith; and display, via the display element, one or more actionable user interface elements on, over, or adjacent to the graphical underlay corresponding to the received identities of the one or more available electronic digital assistant services.

Each of the above-mentioned embodiments will be discussed in more detail below, starting with example communication system and device architectures of the system in which the embodiments may be practiced, followed by an illustration of processing steps for achieving the method, device, and system for an electronic digital assistant query services identification function. Further advantages and features consistent with this disclosure will be set forth in the following detailed description, with reference to the figures.

1. Communication System and Device Structures

a. Communication System Structure

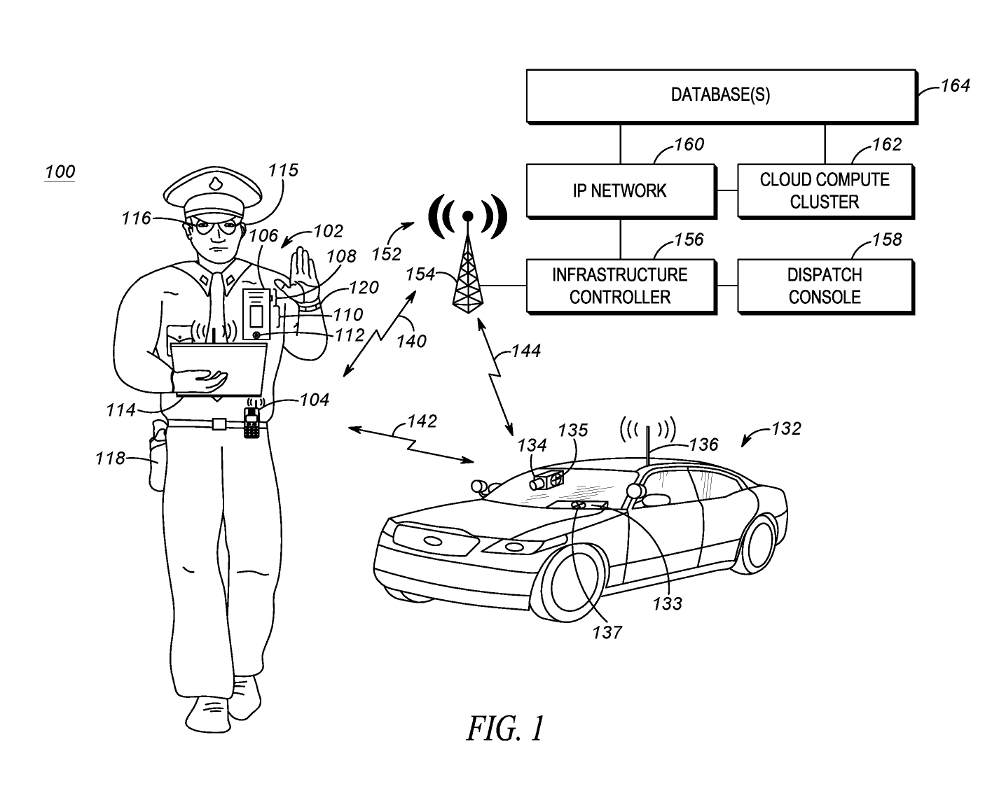

Referring now to the drawings, and in particular FIG. 1, a communication system diagram illustrates a system 100 of devices including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices (wherein the single user 102 and the additional users may form a talkgroup of related users).

System 100 may also include a vehicle 132 associated with the user 102 having an integrated mobile communication device 133, an associated vehicular video camera 134, and a coupled vehicular transceiver 136. Although FIG. 1 illustrates only a single vehicle 132 with a single mobile communication device 133, respective single vehicular video camera 134 and/or microphone 135, single coupled vehicular transceiver 136, and single speaker 137, in other embodiments, the vehicle 132 may include additional same or similar mobile communication devices, video cameras, microphones, speakers, and/or transceivers, and additional vehicles may be present with respective additional sets of mobile communication devices, video cameras, speakers, microphones, and/or transceivers.

Each of the portable radio 104, RSM video capture device 106, laptop 114, and vehicular mobile communication device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits. These devices may be referred to as communication devices and are configured to receive inputs associated with the user 102 and/or provide outputs to the user 102 in addition to communicating information to and from other communication devices and the infrastructure RAN 152.

The portable radio 104, in particular, may be any communication device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (i.e., long-range in comparison to a short-range transmitter such as a Bluetooth, Zigbee, or NFC transmitter) with other communication devices and/or the infrastructure RAN 152. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a USB port, an Ethernet port, an audio jack, etc.) for direct electronic coupling with the RSM video capture device 106, laptop 114, and/or smart glasses 116. In some embodiments, the portable radio 104 may contain a short-range transmitter (i.e., short-range in comparison to the long-range transmitter such as a LMR or broadband transmitter) and/or transceiver for wirelessly coupling with the RSM video capture device 106, laptop 114, and/or smart glasses 116. The short-range transmitter may be a Bluetooth, Zigbee, or NFC transmitter having a transmit range on the order of 0.01-100 meters, or 0.1-10 meters. In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the user's 102 mouth, providing a remote speaker allowing playback of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or to the infrastructure RAN 152. The voice and/or audio played back at the remote speaker may be received from the portable radio 104 or received directly from one or more other communication devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single communication device to communicate with one or more group members (i.e., talkgroup members, not shown in FIG. 1) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a field-of-view associated with the user, perhaps including a suspect and the suspect's surroundings, storing the captured image and/or audio data for further analysis or transmitting the captured audio and/or video data as an audio and/or video stream to the portable radio 104 and/or to other communication devices or to the infrastructure RAN 152 directly for further analysis. An RSM remote microphone of the RSM video capture device 106 may be an omni-directional or unidirectional microphone or array of omni-directional or unidirectional microphones that may be capable of identifying a direction from which a captured sound emanated.

In some embodiments, the RSM video capture device 106 may be replaced with a more limited body worn camera that may include the video camera 112 and/or microphone noted above for capturing audio and/or video, but may forego one or more of the features noted above that transform the body worn camera into a more full featured RSM, such as the separate physical PTT switch 108 and the display screen 110, remote microphone functionality for voice communications in cooperation with portable radio 104, and remote speaker.

The laptop 114, in particular, may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, a white boarding application, and/or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, perhaps including a field-of-view of the user 102 and/or a suspect (or potential suspect) and the suspect's surroundings, and store and/or otherwise process the captured video and/or audio for further analysis or transmit the captured video and/or audio as a video and/or audio stream to the portable radio 104, other communication devices, and/or the infrastructure RAN 152 for further analysis.

An in-ear or over-the ear earpiece or headphone 115 may be present for providing audio to the user in a private fashion that is not accessible to other users nearby the user 102. The earpiece or headphone 115 may be communicatively coupled in a wired or wireless manner to one or both of the RSM 106 and the portable radio 104, which may be configured to provide audio received from the RAN 152 and/or from other users to the user 102 based on a manual configuration of the RSM 106 or the portable radio 104, or based on some automatic routing mechanism at the one of the RSM 106 and the portable radio 104 that may route all audio to the earpiece or headphone 115 whenever it is detected as connected to the one of the RSM 106 and the portable radio 104, or may selectively route audio received at the one of the RSM 106 and the portable radio 104 to the earpiece or headphone 115 based on various contextual parameters, such as a content of the received audio, an identity of who sent the received audio, a covert status of the user 102, an incident status of the user 102, a determination of nearby users associated with the user 102, or some other contextual parameter.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In other embodiments, an additional user interface mechanism such as a touch interface or gesture detection mechanism may be provided at the smart glasses 116 that allows the user 102 to interact with the display elements displayed on the smart glasses 116 or projected into the user's 102 eyes, or to modify operation of the digital imaging device. In still other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact. In some embodiments, the smart glasses 116 may provide an augmented reality interface in which a direct or indirect view of real-world environments in which the user is currently disposed are augmented (i.e., supplemented, by additional computer-generated sensory input such as sound, video, images, graphics, GPS data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiography (EKG) signal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, or other short-range wireless protocol having a transmission range on the order of meters, tens of meters, or hundreds of meters.

The portable radio 104 and/or RSM video capture device 106 (or any other electronic device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 152.

The vehicle 132 associated with the user 102 may include the mobile communication device 133, the vehicular video camera 134 and/or microphone 135, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other communication devices, and/or the infrastructure RAN 152 for further analysis. The omni-directional or unidirectional microphone 135, or an array thereof, may be integrated in the video camera 134 and/or at the vehicular computing device 133 (or additionally or alternatively made available at a separate location of the vehicle 132) and communicably coupled to the vehicular computing device 133 and/or vehicular transceiver 136 for capturing audio and storing, processing, and/or transmitting the audio in a same or similar manner as set forth above with respect to the RSM 106.

Although FIG. 1 illustrates the vehicular video camera 134 and microphone 135 as being placed inside the vehicle 132, in other embodiments, one or both of the vehicular video camera 134 and microphone 135 may be placed at visible or hidden locations outside of the vehicle 132, such as within a vehicular grill portion or bumper portion, or on a roof portion, of the vehicle 132. Further, although FIG. 1 illustrates the single speaker 137 as being placed inside of the vehicle 132 and coupled to the vehicular computing device 133, in other embodiments, multiple speakers may be provided inside and/or outside of the vehicle 132 (all addressed simultaneously or individually addressable for outputting separate audio streams), or the single speaker 137 may be placed outside of the vehicle and function as a PA speaker, among other possibilities.

The vehicle 132 may be a human-operable vehicle, or may be a self-driving vehicle operable under control of mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or transceiver 136, similar to the portable radio 104 and/or respective receivers, transmitters, or transceivers thereof, may include a location (and/or orientation) determination device integrated with or separately disposed in the mobile communication device 133 and/or transceiver 136 for determining (and storing and/or transmitting) a location (and/or orientation) of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras and sensors) within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, or other types of audio and/or video recording devices accessible via a wired or wireless network interface same or similar to that disclosed herein.

Infrastructure RAN 152 is a radio access network that provides for radio communication links to be arranged within the network between a plurality of user terminals. Such user terminals may be portable, mobile, or stationary and may include any one or more of the communication devices illustrated in FIG. 1, among other possibilities. At least one other terminal, e.g. used in conjunction with the communication devices, may be a fixed terminal, e.g. a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated as narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless application, enables familiar PTT and “instant on” features of traditional half duplex communication devices, but uses communication devices operating over modern broadband telecommunications networks. Using OMA-PoC, wireless communication devices such as mobile telephones and notebook computers can function as PTT half-duplex communication devices for transmitting and receiving. Other types of PTT models and multimedia call models (MMCMs) are also available.

Floor control in an OMA-PoC session is generally maintained by a PTT server that controls communications between two or more wireless communication devices. When a user of one of the communication devices keys a PTT button, a request for permission to speak in the OMA-PoC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (e.g., together which form an auditory data stream over time), such as according to RTP and interne protocols (IP), to the PTT server. The PTT server then transmits the auditory data packets to other users of the PoC session (e.g., to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency or frequency & time slot (in which case, in some embodiments, group IDs may be present in the group data to distinguish between groups).

In contrast, a trunked radio system and its communication devices use a pool of traffic channels for virtually an unlimited number of groups of communication devices (and which may also be referred to herein as talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster such as cloud compute cluster 162 communicably coupled to controller 156 via internet protocol (IP) network 160, among other possibilities.

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single infrastructure controller 156 (e.g., a radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices.

The infrastructure controller 156 illustrated in FIG. 1, or some other back-end infrastructure device or combination of back-end infrastructure devices existing on-premises or in the remote cloud compute cluster 162 accessible via the IP network 160 (such as the Internet), may additionally or alternatively operate as a back-end electronic digital assistant, a back-end audio and/or image processing device, and/or a remote cloud-based storage device consistent with the remainder of this disclosure.

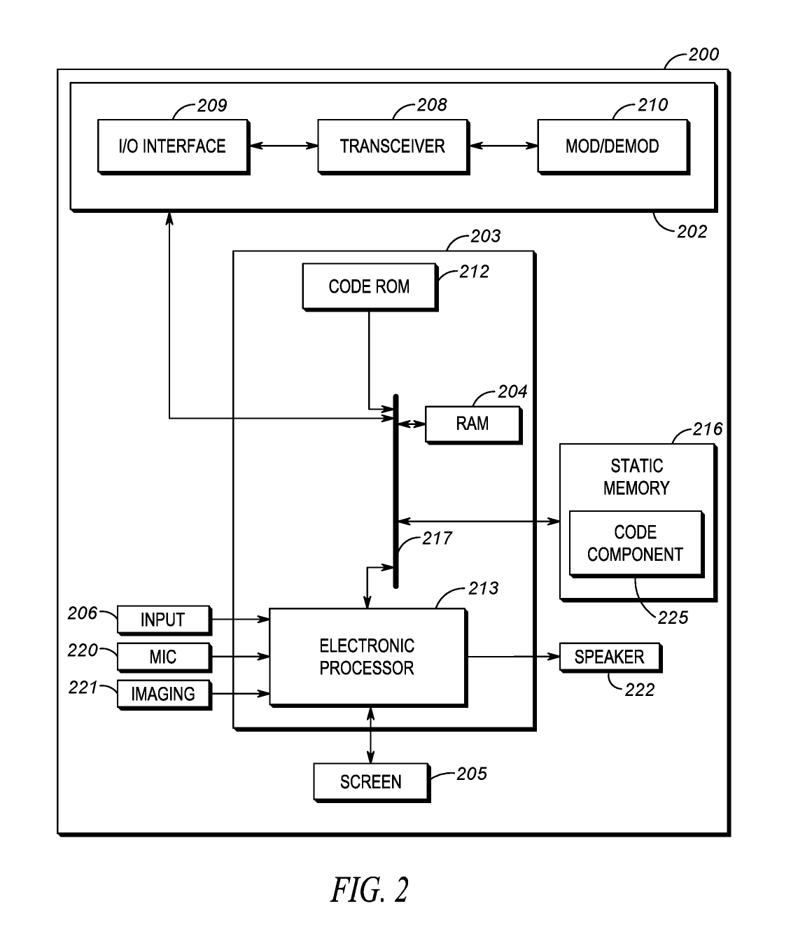

The IP network 160 may comprise one or more routers, switches, LANs, WLANs, WANs, access points, or other network infrastructure, including but not limited to, the public Internet. The cloud compute cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud compute cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

Database(s) 164 may be accessible via IP network 160 and/or cloud compute cluster 162, and may include databases such as a long-term video storage database, a historical or forecasted weather database, an offender database perhaps including a facial recognition database including or referencing images to match against, a cartographic database of streets and elevations, a traffic database of historical or current traffic conditions, a roadblock location database, a vehicular owner and license plate database, a business name and contact information database, a video camera feed locationing and streaming database, or other types of databases. Databases 164 may further include all or a portion of the databases described herein as being provided at infrastructure controller 156. In some embodiments, the databases 164 may be maintained by third parties (for example, the National Weather Service or a Department of Transportation, respectively). As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The databases 164 of FIG. 1 are merely examples. In some embodiments, the system 100 additionally or alternatively includes other databases that store different information. In some embodiments, the databases 164 disclosed herein and/or additional or other databases are integrated with, or internal to, the infrastructure controller 156.

Finally, although FIG. 1 describes a communication system 100 generally as a public safety communication system that includes a user 102 generally described as a police officer and a vehicle 132 generally described as a police car or cruiser, in other embodiments, the communication system 100 may additionally or alternatively be a retail communication system including a user 102 that may be an employee of a retailer and a vehicle 132 that may be a vehicle for use by the user 102 in furtherance of the employee's retail duties (e.g., a shuttle or self-balancing scooter). In other embodiments, the communication system 100 may additionally or alternatively be a warehouse communication system including a user 102 that may be an employee of a warehouse and a vehicle 132 that may be a vehicle for use by the user 102 in furtherance of the employee's retail duties (e.g., a forklift). In still further embodiments, the communication system 100 may additionally or alternatively be a private security communication system including a user 102 that may be an employee of a private security company and a vehicle 132 that may be a vehicle for use by the user 102 in furtherance of the private security employee's duties (e.g., a private security vehicle or motorcycle). In even further embodiments, the communication system 100 may additionally or alternatively be a medical communication system including a user 102 that may be a doctor or nurse of a hospital and a vehicle 132 that may be a vehicle for use by the user 102 in furtherance of the doctor or nurse's duties (e.g., a medical gurney or ambulance). In still another example embodiment, the communication system 100 may additionally or alternatively be a heavy machinery communication system including a user 102 that may be a miner, driller, or extractor at a mine, oil field, or precious metal or gem field and a vehicle 132 that may be a vehicle for use by the user 102 in furtherance of the miner, driller, or extractor's duties (e.g., an excavator, bulldozer, crane, front loader). As one other example, the communication system 100 may additionally or alternatively be a transportation logistics communication system including a user 102 that may be a bus driver or semi-truck driver at a school or transportation company and a vehicle 132 that may be a vehicle for use by the user 102 in furtherance of the driver's duties. Other possibilities exist as well.

b. Device Structure

FIG. 2 sets forth a schematic diagram that illustrates a communication device 200 according to some embodiments of the present disclosure. The communication device 200 may be, for example, embodied in the portable radio 104, the RSM video capture device 106, the laptop 114, the mobile communication device 133, the infrastructure controller 156, the dispatch console 158, one or more computing devices in the cloud compute cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the communication device 200 (for example, the portable radio 104) may be communicatively coupled to other devices such as the sensor-enabled holster 118 as described above. In such embodiments, the combination of the portable radio 104 and the sensor-enabled holster 118 may be considered a single communication device 200.

While FIG. 2 represents the communication devices described above with respect to FIG. 1, depending on the type of the communication device, the communication device 200 may include fewer or additional components in configurations different from that illustrated in FIG. 2. For example, in some embodiments, communication device 200 acting as the infrastructure controller 156 may not include one or more of the screen 205, input device 206, microphone 220, imaging device 221, and speaker 222. As another example, in some embodiments, the communication device 200 acting as the portable radio 104 or the RSM video capture device 106 may further include a location determination device (for example, a global positioning system (GPS) receiver) as explained above. Other combinations are possible as well.

As shown in FIG. 2, communication device 200 includes a communications unit 202 coupled to a common data and address bus 217 of a processing unit 203. The communication device 200 may also include one or more input devices (e.g., keypad, pointing device, touch-sensitive surface, etc.) 206 and an electronic display screen 205 (which, in some embodiments, may be a touch screen and thus also act as an input device 206), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of the communication device 200 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless RAN 152, and/or the mobile communication device 133.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

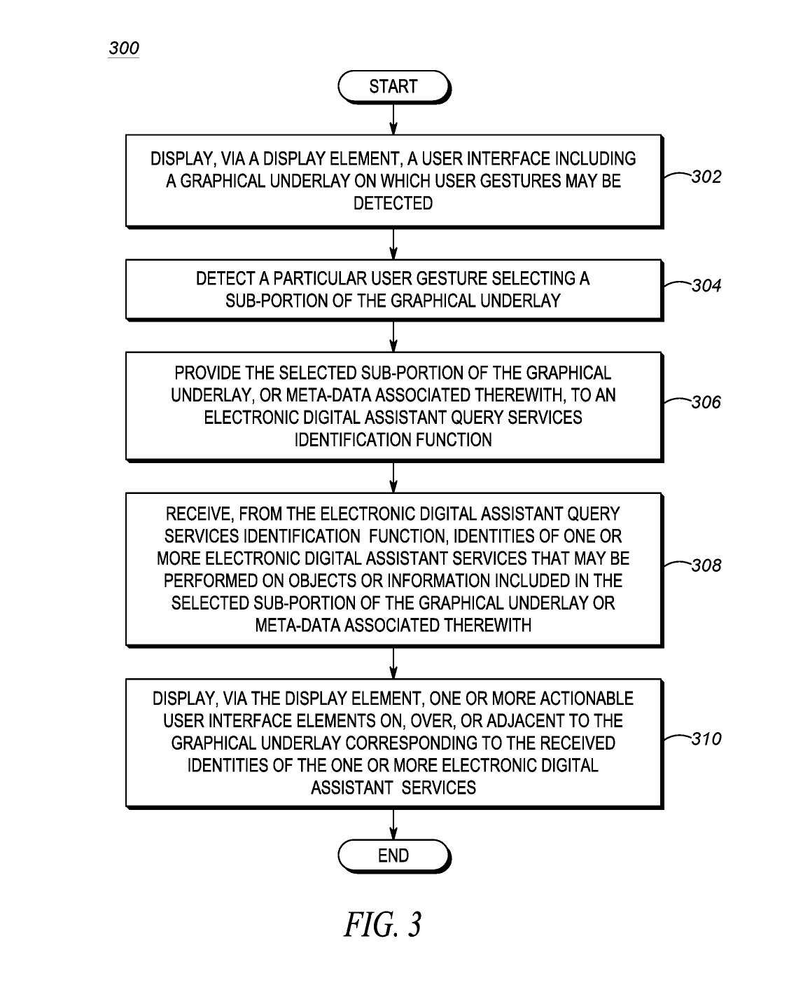

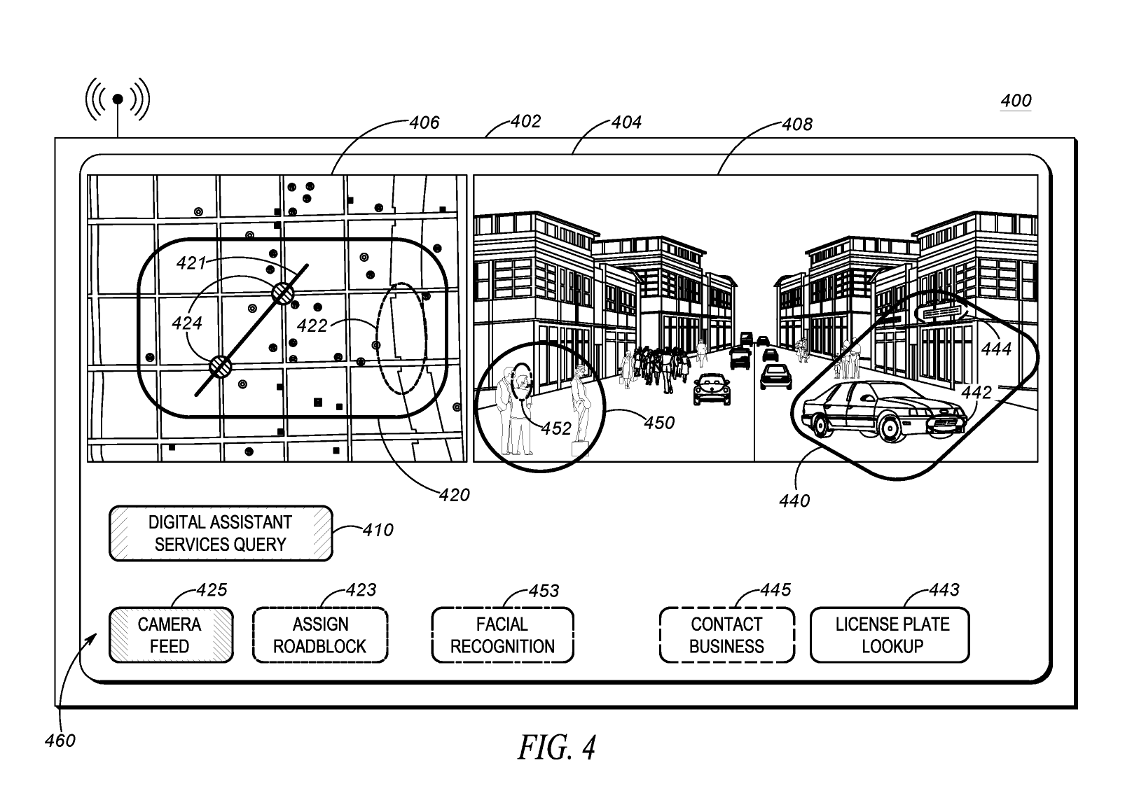

The electronic processor 213 has ports for coupling to the display screen 205, the input device 206, the microphone 220, the imaging device 221, and/or the speaker 222. Static memory 216 may store operating code 225 for the electronic processor 213 that, when executed, performs one or more of the processing steps set forth in FIG. 3 and accompanying text and/or one or more of the user interface steps illustrated in FIG. 4 and accompanying text.

In some embodiments, static memory 216 may also store, permanently or temporarily, one or more of the databases described above with respect to FIG. 1, and/or links or authentication information for accessing the one or more of the databases described above. Static memory 216 may further store a mapping setting forth particular electronic digital assistant services (available locally or remotely), and a single or individual network path locations (e.g., URLs) and perhaps associated security credentials (e.g., tokens, usernames, passwords, keys, etc.) for accessing those electronic digital assistant services remotely or application programming interface (API) definitions for accessing them locally, among other possibilities. Such a mapping may additionally include an indication of whether each particular service is currently available (e.g., operational) or not. Static memory 216 may further store other types of mappings, such as a mapping of identified objects or types of objects and electronic digital assistant services that can be performed on the identified objects or types of objects, a service identity to path mapping that maps an identified electronic digital assistant service by name to a local or network path or API at which it may be accessed, and a service priority mapping that may assign relative priorities to particular electronic digital assistant services, among other possibilities.

The static memory 216 may comprise, for example, a hard-disk drive (HDD), an optical disk drive such as a compact disk (CD) drive or digital versatile disk (DVD) drive, a solid state drive (SSD), a flash memory drive, or a tape drive, and the like.

2. Processes for Identifying and Displaying Available Electronic Digital Assistant Services for Graphical and/or Text Input

In some embodiments, an individual component and/or a combination of individual components of the system 100 may be referred to as an electronic computing device that implements an electronic digital assistant query services identification function. For example, the electronic computing device may be a single electronic processor (for example, the electronic processor 213 of the portable radio 104). In other embodiments, the electronic computing device includes multiple electronic processors distributed remotely from each other. For example, the electronic computing device may be implemented on a combination of at least two of the electronic processor 213 of the portable radio 104, the electronic processor 213 of the infrastructure controller 156, and the electronic processor 213 of a back-end cloud compute cluster 162 accessible via the IP network 160.

Turning now to FIG. 3, a flowchart diagram illustrates a process 300 at an electronic computing device for identifying and displaying available electronic digital assistant services for graphical and/or text input. While a particular order of processing steps, message receptions, and/or message transmissions is indicated in FIG. 3 for exemplary purposes, timing and ordering of such steps, receptions, and transmissions may vary where appropriate without negating the purpose and advantages of the examples set forth in detail throughout the remainder of this disclosure.

Process 300 begins at step 302 where the electronic computing device displays, via a display element communicatively coupled to the electronic computing device, a display portion of a user interface including a graphical underlay on which user gestures may be detected. The display element may be physically integrated with the electronic computing device, or may be physically separate from the electronic computing device but wiredly or wirelessly coupled to the electronic computing device. For example, the electronic computing device may be a tablet or laptop computing device similar to laptop 114 of FIG. 1, or may be a vehicular console device similar to mobile computing device 133 of FIG. 1. In other embodiments, the display portion may be a holographic image projected in space or an image projected against a wall, screen, or other physical reflective surface or directly into an eye of a user, or may be part of an augmented or mixed reality display system. Other possibilities exist as well.

The user interface at the electronic computing device provides a mechanism by which a user may interact with the electronic computing device and includes both the display portion set forth in step 302 and an input portion that captures a user gesture as will be described in more detail with respect to step 304. The graphical underlay may be any combination of graphic (e.g., image and/or symbol) and/or textual (e.g., alphanumeric) content that conveys information to a user and on which the user may perform a gesture via the input portion of the user interface.

FIG. 4 illustrates example graphical underlays 406 and 408 of a display portion 404 of a user interface 400 at an electronic computing device 402. Graphical underlays 406 and 408 are illustrated in FIG. 4 as part of a whiteboarding application, but in other embodiments, may be graphical underlays that are part of any application, including but not limited to a mapping application, an image viewing and/or editing application, an evidence management application, an incident management application, or any other type of similar or different application.

Graphical underlay 406, in particular, illustrates a cartographic representation underlay that may include any number or type of street indications, street name text, intersection indications, building indications, building address or business name text, body of water indications, video camera location and/or identification indications, first responder location indications, drone location and/or identification indications, or any other type of indication that can be associated with a particular geographic location relative to the cartographic representation displayed. The graphical underlay 406 may be generated, for example, by a known cartographic mapping application such as Google Maps™ or HERE Maps™ with or without custom layers added thereon, or may be an entirely custom-generated cartographic representation stored locally or retrieved from an associated infrastructure or cloud-based storage. As just one example, the cartographic representation in graphical underlay 406 may illustrate an incident location where a user operating the electronic computing device may wish to perform some incident-related actions or operations via the electronic computing device user interface 400 relative to the incident.

Graphical underlay 408, on the other hand, illustrates a captured user field-of-view representation underlay that may include any number or type of real-world users, objects, symbols, text, or anything else that may be present in a visible-wavelength electronically capturable scene. The graphical underlay 408 may be generated, for example, by a body camera such as RSM video capture device 106, by a camera integrated with the electronic computing device such as by laptop 114 of FIG. 1, by a vehicular video camera 134, or by some other electronic capture device and communicatively provided to the electronic computing device via a wired and/or wireless connection. As just one example, the captured user field-of-view representation underlay in graphical underlay 408 may illustrate a field-of-view associated with a user operating the electronic computing device that may wish to perform some actions or operations via the electronic computing device user interface 400 relative to what the user sees in his or her own field-of-view.

At step 304, the electronic computing device detects a particular user gesture selecting a sub-portion of the graphical underlay. The particular user gesture is detected via the input portion of the user interface at the electronic computing device. The input portion may be, for example, integrated with the display element displaying the graphical underlay such as via a resistive or capacitive touch-sensitive surface integrated into the display element described above at step 302. In other embodiments, the input portion may be separate from the display element and may include a touch pad separate from the display element. In still further embodiments, the input portion may be an imaging camera (depth imaging, 2-D visual wavelength imaging, infrared imaging, etc.) that can detect a user gesture in free space selecting a sub-portion of the projected graphical underlay. Other examples are possible as well.

The sub-portion of the graphical underlay (which itself may include one or more layers of information/overlays) is any sub-portion of the entire two-dimensional (or, in some cases, three-dimensional) displayed graphical underlay that is less than the entire displayed graphical underlay. For a touch-sensitive user interface mechanism such as those described above, the sub-selection may be in the form of a drawn geometric shape such as a circle, square, or oval that encompasses a sub-portion of the displayed graphical underlay. In other embodiments, the sub-selection may take the form of a selection of a sub-portion of all identifiable elements or objects in the graphical underlay. In still further embodiments, the sub-selection may take the form of a line drawn across the graphical underlay that intersects a sub-portion of all selectable elements or objects in the graphical underlay. Other examples are possible as well. For a free-space input mechanism, the sub-selection may take the form of a detected user gesture circling a sub-portion of an entire field-of-view of a projected display by the user with his or her finger, which may then be detected and identified via a image processing process at the electronic computing device. Additionally or alternatively, the sub-selection may take the form of a detected user gesture creating a square that encompasses a sub-portion of the projected display by the user with his or her hands, arms, and/or fingers, which may then be detected and identified via a image processing process at the electronic computing device. Other examples are possible as well.

Referring again to FIG. 4, and as one example with respect to the display portion 404 of the user interface 400 of electronic computing device 402, a user gesture detected at step 304 may take the form of a user drawing an oval 420 around a plurality of intersections of roads and a plurality of camera feeds on cartographic representation graphical underlay 406 to sub-select a sub-portion of the cartographic representation graphical underlay 406 that is encompassed by the oval 420. As another example, a user gesture detected at step 304 may take the form of a user drawing a straight line 421 intersecting a plurality of camera feeds on a cartographic representation graphical underlay 406 to sub-select a sub-portion of the cartographic representation graphical underlay 406 that intersects or is within a threshold distance (e.g., such as 5, 50, or 500 pixels, or 5, 50, or 500 feet based on an underlying scale of the cartographic representation graphical underlay 406) of the straight line 421. As a still further example, a user gesture detected at step 304 may take the form of a user drawing a plurality of circles 440, 450 to sub-select a plurality of sub-portions of the captured user field-of-view representation graphical underlay 408 that is encompassed by the circles 440, 450.

In a particular example where the graphical underlays 406 and/or 408 are displayed as part of a whiteboarding application, a particular electronic digital assistant query services identification tool may be enabled via an associated electronic digital assistant query services identification function user interface element 410 as shown in FIG. 4, after which time further user gestures detected at the electronic computing device while the electronic digital assistant query services identification tool is active may trigger the remaining steps 306-310 disclosed in FIG. 3. In other examples, other types of tools or features in other types of applications may trigger the remaining steps 306-310 disclosed in FIG. 3, and in some examples, the remaining steps 306-310 disclosed in FIG. 3 may be triggered as a default action without having to select or enable a particular electronic digital assistant query services identification tool via an associated electronic digital assistant query services identification function user interface element 410 such as that shown in FIG. 4.

At step 306, the electronic computing device provides the selected sub-portion of the graphical underlay, or metadata associated therewith, to an electronic digital assistant query services identification function. The electronic digital assistant query services identification function is a function that may run locally at the electronic computing device (e.g., and may be accessible via a local application programming interface (API) call to a local native or JAVA application), or remotely at a remote computing device (e.g., and may be accessible via a remote API call or via a URL to a JAVA or AJAX web application), and identifies (and/or provides access to) one or more electronic digital assistant services (again, that may be available locally and/or remotely) that are available to aid a user in finding additional information relative to the selected sub-portion, such as contact or ownership information, executing or assigning tasks, retrieving media feeds, and correlating information with prior information, among other possibilities. The electronic digital assistant query services identification function may receive the selected sub-portion of the graphical underlay, or metadata associated therewith, and based on an analysis of the contents of the selected sub-portion of the graphical underlay, determine which electronic digital assistant services are available to further aid the user in a corresponding manner. Accordingly, the electronic digital assistant query services identification function acts as an electronic digital assistant search function for identifying which electronic digital assistant services are available and relevant to (e.g., can provide additional information, execute or assign tasks, retrieve media feeds, and/or correlate information in the sub-portion with prior stored or retrieved information) the contents of the selected sub-portion, and which can be indicated as actionable to the user via a further actionable user interface element on, over, or adjacent to the graphical underlay to allow the user to formally execute and/or request a particular electronic digital assistant service identified by the electronic digital assistant query services identification function to operate relative to the selected sub-portion.

As illustrated in FIG. 4, the selected sub-portion of the graphical underlay or metadata associated therewith, with respect to oval 420 drawn over cartographic representation graphical underlay 406 may include a graphical copy of the cartographic representation graphical underlay 406 within the oval 420 (which may include only the selected sub-portion of the entire graphical underlay or may include the entire graphical underlay with an indication of where the sub-selection was made) or may include metadata associated with the cartographic representation graphical underlay 406 within the oval 420, and the selected sub-portion provided to (if local) or transmitted to (if remote) the electronic digital assistant query services identification function at step 306 may include the graphical copy and/or the metadata. By sending the graphical copy, a full set of graphical information is provided to the electronic digital assistant query services identification function, but the electronic digital assistant services query identification function may be required to expend additional processing power recognizing the context and/or objects, symbols, text, etc. included in the graphical copy before determining which electronic digital assistant services should be displayed as available relative to the selected sub-portion.

Accordingly, in addition to or in place of the graphical copy of the cartographic graphical underlay 406 within the oval 420, the electronic computing device may provide metadata associated with the selected sub-portion to the electronic digital assistant query services identification function. For example, metadata associated the selected sub-portion of the cartographic graphical underlay 406 within the oval 420 may include longitude and latitude coordinates defining the region encompassed by oval 420, may include address ranges and street names (and/or intersections) defining the region encompassed by oval 420, or may include street names operating as borders associated with the region encompassed by oval 420, among other possibilities. Same or similar graphical sub-portion or meta-data associated therewith may be provided relative to the user drawn line 421 selecting a sub-portion of the cartographic graphical underlay 406 that falls directly under the line 421 or within a threshold distance of the line as already described earlier.

As further illustrated in FIG. 4, the selected sub-portion of the graphical underlay or metadata associated therewith, with respect to circles 440, 450 drawn over the captured user field-of-view representation graphical underlay 408 may include a graphical copy of the field-of-view graphical underlay 408 within the respective circles 440, 450 or may include metadata associated with the field-of-view graphical underlay 408 within the respective circles 440, 450, and the selected sub-portion provided to (if local) or transmitted to (if remote) the electronic digital assistant query services identification function at step 306 may include the graphical copy and/or the metadata. For example, metadata associated the selected sub-portion of the field-of-view graphical underlay 408 within the respective circles 440, 450, may include longitude and latitude coordinates defining a projected geographic region identified by circles 440, 450, may include identification information associated with a facial recognition match performed at the electronic computing device on a graphical image of a human face included in the selected sub-portion of the field-of-view graphical underlay 408 within the respective circles 440, 450, may include identification information associated with street signs, business names, and/or license plates identified via an optical character recognition process performed at the electronic computing device on a graphical image including alphanumeric text (e.g., from a business sign, a street sign, a license plate, etc.) included in the selected sub-portion of the field-of-view graphical underlay 408 within the respective circles 440, 450, and/or may include object identification (e.g., Ford Taurus sedan) and/or parameter information (e.g., blue paint, white sidewall tires, etc.) for objects identified via an object recognition process performed at the electronic computing device on the selected sub-portion of the field-of-view graphical underlay 408 within the respective circles 440, 450, among other possibilities.

Although the above descriptions with respect to FIG. 4 all refer to a public safety specific electronic digital assistant query services identification function and one or more available public-safety specific electronic digital assistant services, in other embodiments, a more generalized non-public-safety specific electronic digital assistant query services identification function may be provided that may have access to or have knowledge of how to access non-public-safety specific electronic digital assistant services, such as ad-tracking services, building identification services, word definition services, employee tracking services, package identification services, group discussion services, or any other type of electronic digital assistant service.

At step 308, the electronic computing device receives, from the electronic digital assistant query services identification function, identities of one or more electronic digital assistant services that may be performed on objects or information included in the selected sub-portion of the graphical underlay or metadata associated therewith (e.g., but which have not yet been actually performed and/or results not provided back to the electronic computing device). The identities of one or more electronic digital assistant services may be received in a same or similar manner as set forth in step 306 above, i.e., via a locally available API or native application or via a remote API or JAVA or AJAX application, among other possibilities.

The identities of the one or more electronic digital assistant services may be determined by the electronic digital assistant query services identification function in a number of different ways. As set forth with respect to step 306, the electronic digital assistant query services identification function may receive the selected sub-portion of the graphical underlay itself, or metadata associated therewith. In the event the electronic digital assistant query services identification function receives the selected sub-portion of the graphical underlay itself, it may perform an object recognition image processing function itself to identify objects, text, symbols, and other information in the selected sub-portion of the graphical underlay that it can use to determine which electronic digital assistant services are appropriate to offer relative to the identified objects, text, symbols, and other information in the selected sub-portion. The image processing algorithm generates object information which may then be provided to the image processing electronic computing device (which may be the same or different from the electronic computing device performing process 300), which may then store the object information and any other corresponding metadata (including audio, colors, shades, etc.) in a non-volatile store for future reference and/or further processing.

The identified object(s) may be any type of material thing that can be seen and (hypothetically though not literally) touched by the user, such as a person, building, tool, animal, sign, event, vehicle, street, or other type of object. The electronic digital assistant query services identification function may apply an object-recognition algorithm having access to a database of exemplary known objects, or a trained machine learning model trained to identify particular objects, to the received selected sub-portion and identify one or more objects that match known object(s) from the object recognition database or trained model. Various image processing algorithms may be used to match objects in the selected sub-portion to an exemplary known object, including but not limited to geometric hashing, edge detection, scale-invariant feature transform (SIFT), speeded-up robust features (SURF), neural networks, deep learning, genetic, gradient-based and derivative-based matching approaches, Viola-Jones algorithm, template matching, or image segmentation and blob analysis. Other possibilities exist as well.

Once an object is matched, metadata describing the object from the object recognition database (e.g., identifying the object as a person, a vehicle, a building, a tool, an animal, a sign, an event, a vehicle, a street, or some other type of object) may be embedded and stored within the graphical image selected sub-portion prior to storing it (in a volatile and/or non-volatile store), or may be stored in a separate metadata file and stored accompanying the graphical image selected sub-portion (and both associated with the user). Additional metadata regarding the identified object may be identified and/or extracted from the selected sub-portion or extracted from the metadata also received from the electronic computing device, including but not limited to a color of the object, a time (point in time or a time window, a location, a role and/or identity of the user that generated the selected sub-portion, a current incident with which the user is currently associated, or some other contextual or parameterized information.

In other embodiments, and as noted above, the electronic digital assistant query services identification function may receive metadata associated with the selected sub-portion of the graphical underlay and may be able to operate directly on the received metadata without performing the image processing steps noted above.

The electronic digital assistant query services identification function may then access a database or mapping of identified objects or types of objects, and identify one or more available electronic digital assistant services that can be performed on the objects or information included in the selected sub-portion. One advantage of not executing every available electronic digital assistant service automatically (and without further user request via user input) is that each electronic digital assistant service consumes processing time and power, and performing all available electronic digital assistant services may require a large (and generally unavailable) amount of processing time and power. Furthermore, presenting numerous electronic digital assistant services results to a user at a same time is likely to confuse the user and the user may refrain from using any of the electronic digital assistant services as a result. Still further, new electronic digital assistant services may be added and old electronic digital assistant retired at any time.

The database or mapping of identified objects or types of objects to available electronic digital assistant services that can be performed on the objects or information included in the selected sub-portion may take the form of the mapping set forth in Table I.

TABLE I
Example Object/Information to Electronic Digital Assistant Service Mapping

| Type of Object/ | Electronic Digital | Currently | |
|---|---|---|---|
| Information | Assistant Services | Available? | Path to Service |
| Car | License Plate Lookup | Y | URL://Plate.Lookup/ |
| | Insurance Status Lookup | Y | URL://Insurance.Lookup/ |
| | Warrant Status Lookup | N | <NULL> |
| Business Sign | Contact Information Lookup | Y | URL://BizContact.Lookup/ |
| | Past Incident Lookup | N | <NULL> |
| Human Face | Run Facial Recognition | Y | URL://Facial.Recog/ |
| | Send to Talkgroup | Y | URL://Sendto.TG/ |
| | Run Warrant Check | N | <NULL> |
| Street or | Place a Roadblock | Y | URL://Place.Roadblock/ |
| Intersection | Dispatch an Officer | N | <NULL> |
| | Access a Camera Feed | Y | URL://Camera.Feeds/ |

As set forth in Table I above, each object or information identified in the selected sub-portion may be mapped to one or more available electronic digital assistant services that may be performed on the identified object or information. The electronic digital assistant query services identification function may thus access such a mapping as set forth in Table I and identify not only each associated electronic digital assistant service, but also (and optionally) whether that service is currently available (e.g., accessible and operational). The electronic digital assistant query services identification function may periodically check a status of the path to each electronic digital assistant service stored in the mapping, and determine whether the path is accurate and/or whether the service is available and responding to query requests. Accordingly, the electronic digital assistant query services identification function can provide back to the electronic computing device only those electronic digital assistant services that are associated with objects or information in the received selected sub-portion (or metadata associated therewith), but also only those electronic digital assistant services that are available (and operational). Assuming that some of the electronic digital assistant services are not available locally, a URL path as set forth in Table I (or an API identification, among other possibilities) may also be stored in the mapping and identify a path for accessing the associated electronic digital assistant service.

Accordingly, and turning now to the example set forth in FIG. 4, an electronic digital assistant query services identification function storing the mapping set forth in Table I above and in receipt of the selected sub-portion of the graphical underlay or metadata associated therewith, with respect to oval 420 drawn over cartographic representation graphical underlay 406 may identify, via metadata received from the electronic computing device or information extracted from the sub-portion in a manner as set forth above, streets and/or intersections and determine, via reference to the mapping set forth in Table I, that a roadblock placement electronic digital assistant service is available for such objects (and perhaps also determine that such service is currently available via the maintained status entry in the mapping or via a real-time query to the service), and return information to the electronic computing device indicating the location or locations in the selected sub-portion where the roadblock placement electronic digital assistant service is available (e.g., indicating the location or locations indicated via oval 422 as a further sub-portion of the selected sub-portion of the graphical underlay 406) and perhaps including a name or path to the API or URL at which the roadblock placement electronic digital assistant service can be accessed if and/or when activated by a user of the electronic computing device. In some embodiments, the electronic digital assistant query services identification function may return the roadblock placement electronic digital assistant service for all streets and/or intersections identified in the selected sub-portion without accessing the roadblock placement electronic digital assistant service itself, while in other embodiments, the electronic digital assistant query services identification function may access the roadblock placement electronic digital assistant service with respect to the identified streets and/or intersections in the selected sub-portion and receive, in response, a more limited identification of which ones of those identified streets and/or intersections in the selected sub-portion at which the roadblock placement electronic digital assistant service is available. For example, and as shown in FIG. 4, deployable roadblocks that may rise from a below-grade street level may only be available at the street locations indicated by oval 422, while in other embodiments, they may be available elsewhere as well. By accessing the roadblock placement electronic digital assistant service on behalf of the electronic computing device, the electronic digital assistant query services identification function may further refine the locations within the selected sub-portion that the roadblock placement electronic digital assistant service itself indicates the roadblock placement electronic digital assistant service to be available (e.g., without actually running the service relative to the indicated location and deploying or dispatching roadblocks to those locations at this time).

In some embodiments, the electronic digital assistant query services identification function may also return to the electronic computing device one or more actionable user interface elements to display on, over, or adjacent the graphical underlay that, once activated, cause the electronic computing device to access the corresponding electronic digital assistant service. For example, in this case, and although not illustrated in FIG. 4, the electronic digital assistant query services identification function may provide a roadblock icon and button design to the electronic computing device for placement on, over, or adjacent the graphical underlay 406 for indicating the availability of the roadblock placement electronic digital assistant service and provide the path to the roadblock placement electronic digital assistant service (URL://Place.Roadblock/) that may be accessed responsive to the user activating the provided actionable user interface element(s). Additionally or alternatively, and as shown in FIG. 4, an “Assign Roadblock” actionable user interface element 423 may be positioned on, over, or adjacent the graphical underlay 406, and uniquely colored, shaped, or otherwise formed to visually link the “Assign Roadblock” actionable user interface element 423 to the associated sub-portion of the graphical underlay 406 indicated by oval 422 and associated with the roadblock placement electronic digital assistant service.

Additionally or alternatively, the electronic digital assistant query services identification function storing the mapping set forth in Table I above and in receipt of the selected sub-portion of the graphical underlay or metadata associated therewith, with respect to oval 420 drawn over cartographic representation graphical underlay 406 may identify, via metadata received from the electronic computing device or information extracted from the sub-portion in a manner as set forth above, streets and/or intersections and determine, via reference to the mapping set forth in Table I, that an access camera feed electronic digital assistant service is available for such objects (and perhaps also determine that such service is currently available via the maintained status entry in the mapping or via a real-time query to the service), and return information to the electronic computing device indicating the location or locations in the selected sub-portion where the access camera feed electronic digital assistant service is available (e.g., indicating the location or locations indicated via circular symbols 424 as a further sub-portion of the selected sub-portion of the graphical underlay 406) and perhaps including a name or path to the API or URL at which the access camera feed electronic digital assistant service can be accessed if and/or when activated by a user of the electronic computing device. In some embodiments, the electronic digital assistant query services identification function may return the access camera feed electronic digital assistant service for all streets and/or intersections identified in the selected sub-portion without accessing the access camera feed electronic digital assistant service itself, while in other embodiments, the electronic digital assistant query services identification function may access the access camera feed electronic digital assistant service with respect to the identified streets and/or intersections in the selected sub-portion and receive, in response, a more limited identification of which ones of those identified streets and/or intersections in the selected sub-portion at which the access camera electronic digital assistant service is available (e.g., those locations with accessible and available video cameras). For example, and as shown in FIG. 4, video cameras that may be accessed to provide recorded or streamed video content may only be available at the locations indicated by circular symbols 424, while in other embodiments, they may be available elsewhere as well. By accessing the access camera electronic digital assistant service on behalf of the electronic computing device, the electronic digital assistant query services identification function may further refine the locations within the selected sub-portion that the access camera electronic digital assistant service indicates the access camera electronic digital assistant service to be available (e.g., without actually running the service relative to the indicated location and beginning to receive one or more video streams at this time).

In some embodiments, the electronic digital assistant query services identification function may also return to the electronic computing device one or more actionable user interface elements to display on, over, or adjacent the graphical underlay that, once activated, cause the electronic computing device to access the corresponding electronic digital assistant service. For example, in this case, and although not illustrated in FIG. 4, the electronic digital assistant query services identification function may provide a video camera icon and button design to the electronic computing device for placement on, over, or adjacent the graphical underlay 406 for indicating the availability of the access camera electronic digital assistant service and provide the path to the access camera electronic digital assistant service (URL://Camera.Feeds/) that may be accessed responsive to the user activating the provided actionable user interface element(s). Additionally or alternatively, and as shown in FIG. 4, a “Camera Feed” actionable user interface element 425 may be generated by the electronic computing device in response to receiving the identification of the available electronic digital assistant services at step 308 and may be positioned on, over, or adjacent the graphical underlay 406, and uniquely colored, shaped, or otherwise formed to visually link the “Camera Feed” actionable user interface element 425 to the associated sub-portion of the graphical underlay 406 indicated by circular symbols 424 and associated with the access camera electronic digital assistant service.

As another example, the electronic digital assistant query services identification function storing the mapping set forth in Table I above and in receipt of the selected sub-portion of the graphical underlay or metadata associated therewith, with respect to circle 440 drawn over the captured user field-of-view representation graphical underlay 408 may identify, via metadata received from the electronic computing device or information extracted from the sub-portion in a manner as set forth above, objects including a car and a business sign and determine, via reference to the mapping set forth in Table I, that a license plate lookup electronic digital assistant service is available for the car object (and perhaps also determine that such service is currently available via the maintained status entry in the mapping or via a real-time query to the service) and that a contact information lookup electronic digital assistant service is available for the business sign object (and perhaps also determine that such service is currently available via the maintained status entry in the mapping or via a real-time query to the service), and return information to the electronic computing device indicating the location or locations in the selected sub-portion where the respective electronic digital assistant services are available (e.g., indicating the location or locations indicated via ovals 442 and 444 as further sub-portions of the selected sub-portion of the graphical underlay 408) and perhaps including a name or path to the API(s) or URL(s) at which the respective electronic digital assistant services can be accessed if and/or when activated by a user of the electronic computing device. In some embodiments, the electronic digital assistant query services identification function may return the license plate lookup electronic digital assistant service for all vehicular license plates identified in the selected sub-portion without accessing the license plate lookup electronic digital assistant service itself, while in other embodiments, the electronic digital assistant query services identification function may access the license plate lookup electronic digital assistant service with respect to the identified vehicular license plates in the selected sub-portion and receive, in response, a more limited identification of which ones of those identified vehicular license plates have outstanding warrant and/or may be related to an incident with which the user is currently involved or assigned. In still other embodiments, the electronic digital assistant query services identification function may return the contact information lookup electronic digital assistant service for all business signs identified in the selected sub-portion without accessing the contact information lookup electronic digital assistant service itself, while in other embodiments, the electronic digital assistant query services identification function may access the contact information lookup electronic digital assistant service with respect to the identified business signs in the selected sub-portion and receive, in response, a more limited identification of which ones of those identified business signs have expired licenses and/or may be related to an incident with which the user is currently involved or assigned.

In some embodiments, the electronic digital assistant query services identification function may also return to the electronic computing device one or more actionable user interface elements to display on, over, or adjacent the graphical underlay that, once activated, cause the electronic computing device to access the corresponding electronic digital assistant service. For example, in this case, and although not illustrated in FIG. 4, the electronic digital assistant query services identification function may provide an address book icon and button design to the electronic computing device for placement on, over, or adjacent the graphical underlay 408 for indicating the availability of the contact information lookup electronic digital assistant service and provide the path to the contact information lookup electronic digital assistant service (URL://BizContact.Lookup/) that may be accessed responsive to the user activating the provided actionable user interface element.

Additionally or alternatively, and as shown in FIG. 4, a “Contact Business” actionable user interface element 445 may be generated by the electronic computing device in response to receiving the identification of the available electronic digital assistant services at step 308 and may be positioned on, over, or adjacent the graphical underlay 408, and uniquely colored, shaped, or otherwise formed to visually link the “Contact Business” actionable user interface element 445 to the associated sub-portion of the graphical underlay 408 indicated by oval 444 and associated with the contact information lookup electronic digital assistant service.

Similarly, the electronic digital assistant query services identification function may provide a driver's license icon and button design to the electronic computing device for placement on, over, or adjacent the graphical underlay 408 for indicating the availability of the license plate lookup electronic digital assistant service and provide the path to the license plate lookup electronic digital assistant service (URL://Plate.Lookup/) that may be accessed responsive to the user activating the provided actionable user interface element(s).

Additionally or alternatively, and as shown in FIG. 4, a “License Plate Lookup” actionable user interface element 443 may be generated by the electronic computing device in response to receiving the identification of the available electronic digital assistant services at step 308 and may be positioned on, over, or adjacent the graphical underlay 408, and uniquely colored, shaped, or otherwise formed to visually link the “License Plate Lookup” actionable user interface element 443 to the associated sub-portion of the graphical underlay 408 indicated by oval 442 and associated with the license plate lookup electronic digital assistant service.

As a final example, the electronic digital assistant query services identification function storing the mapping set forth in Table I above and in receipt of the selected sub-portion of the graphical underlay or metadata associated therewith, with respect to circle 450 drawn over the captured user field-of-view representation graphical underlay 408 may identify, via metadata received from the electronic computing device or information extracted from the sub-portion in a manner as set forth above, objects including a human face (e.g., via a facial detection algorithm performed at the electronic digital assistant query services identification function or at the electronic computing device instead of a facial recognition algorithm) and determine, via reference to the mapping set forth in Table I, that a facial recognition electronic digital assistant service is available for the human face object (and perhaps also determine that such service is currently available via the maintained status entry in the mapping or via a real-time query to the service), and return information to the electronic computing device indicating the location or locations in the selected sub-portion where the facial recognition electronic digital assistant service is available (e.g., indicating the location or locations indicated via oval 452 as a further sub-portion of the selected sub-portion of the graphical underlay 408) and perhaps including a name or path to the API or URL at which the facial recognition electronic digital assistant services can be accessed if and/or when activated by a user of the electronic computing device. In some embodiments, the electronic digital assistant query services identification function may return the facial recognition electronic digital assistant service for all human faces detected in the selected sub-portion without accessing the facial recognition electronic digital assistant service itself, while in other embodiments, the electronic digital assistant query services identification function may access the facial recognition electronic digital assistant service with respect to the detected human faces in the selected sub-portion and receive, in response, a more limited identification of which ones of those identified human faces can be identified with a minimum confidence level, which ones of those identified human faces have outstanding warrants, and/or which ones of those identified human faces may be related to an incident with which the user is currently involved or assigned, among other possibilities (e.g., without actually returning personally identifiable information from the facial recognition electronic digital assistant service to the electronic computing device at this time).

In some embodiments, the electronic digital assistant query services identification function may also return to the electronic computing device one or more actionable user interface elements to display on, over, or adjacent the graphical underlay that, once activated, cause the electronic computing device to access the corresponding electronic digital assistant service. For example, in this case, and although not illustrated in FIG. 4, the electronic digital assistant query services identification function may provide a human face icon and button design to the electronic computing device for placement on, over, or adjacent the graphical underlay 408 for indicating the availability of the facial recognition information lookup electronic digital assistant service and provide the path to the facial recognition electronic digital assistant service (URL://Facial.Recog/) that may be accessed responsive to the user activating the provided actionable user interface element.

Additionally or alternatively, and as shown in FIG. 4, a “Facial Recognition” actionable user interface element 453 may be generated by the electronic computing device in response to receiving the identification of the available electronic digital assistant services at step 308 and positioned on, over, or adjacent the graphical underlay 408, and uniquely colored, shaped, or otherwise formed to visually link the “Facial Recognition” actionable user interface element 453 to the associated sub-portion of the graphical underlay 408 indicated by oval 452 and associated with the facial recognition electronic digital assistant service.

At step 310, the electronic computing device displays, via the display element, one or more actionable user interface elements on, over, or adjacent to the graphical underlay corresponding to the received identities of the one or more available electronic digital assistant services. Once activated by a user gesture relative to the one or more actionable user interface elements, such as touching a particular actionable user interface element via a touch sensitive display, the corresponding electronic digital assistant service is executed on the objects or information in the selected sub-portion of the graphical underlay with which the actionable user interface element is associated. As noted earlier, other types of user gestures could be used to activate a displayed actionable user interface element, such as detecting a user's free space pointing at a projected actionable user interface element via an image capture device and image processing algorithm, or detection of a user dictating an instruction to execute a particular corresponding electronic digital assistant service associated with a particular displayed actionable user interface element. Other possibilities exist as well.

Once an activation of one of the displayed actionable user interface elements is detected at the electronic computing device, the corresponding electronic digital assistant service is executed (locally or remotely) on the objects or information in the selected sub-portion of the graphical underlay with which the actionable user interface element is associated, and an output generated by the corresponding electronic digital assistant service (generated locally or remotely and transmitted back to the electronic computing device) may be displayed in the display element, on, over, adjacent to, or in place of, the graphical underlay with which the actionable user interface element is associated.

For example, and with reference again to FIG. 4, user activation of the displayed “Camera Feed” actionable user interface element 425 may cause the electronic computing device to contact the access camera electronic digital assistant service associated with the element 425, perhaps via the path to the service provided to the electronic computing device by the electronic digital assistant services query identification function at step 308 (or stored locally at the electronic computing device as a service identity to path mapping and identified by referencing the mapping at the electronic computing device using the identity of the electronic digital assistant service associated with the “Camera Feed” actionable user interface element 425 and provided by the electronic digital assistant query services identification function) and receive, in response, one or more digital video camera feed streams from video cameras associated with circular symbols 424. The digital video camera feeds from video cameras associated with circular symbols 424 may be placed on, over, or adjacent to the graphical underlay(s) 406, 408, or may replace the graphical underlay(s) 406, 408 in the display portion 404 of the user interface 400 at the electronic computing device 402. The access camera electronic digital assistant service may identify the video cameras associated with circular symbols 424 in any number of different ways. In one embodiment, the electronic computing device may provide the selected sub-portion of the graphical underlay, or metadata associated therewith, to the access camera electronic digital assistant service in a same or similar manner as set forth above with respect to the electronic digital assistant query services identification function, and the access camera electronic digital assistant service may process the selected sub-portion of the graphical underlay in much the same way as the electronic digital assistant query services identification function to identify the video cameras associated with circular symbols 424.

Alternatively, and in those cases where the electronic digital assistant query services identification function contacted the access camera electronic digital assistant service to further identify, limit, and/or filter where the access camera electronic digital assistant service is available relative to the selected sub-portion of the graphical underlay, the electronic digital assistant query services identification function may provide one or more unique identifiers (that, e.g., identify the cameras themselves or locations in the selected sub-portion at which the cameras are located) associated with the particular video cameras indicated by circular symbols 424 back to the electronic computing device for further transmission back to the access camera electronic digital assistant service upon activation of the “Camera Feed” actionable user interface element 425 so that the access camera electronic digital assistant service does not need to re-process the selected sub-portion of the graphical underlay, or metadata associated therewith, to identify the particular video cameras (or locations thereof) indicated by circular symbols 424. In a still further embodiment, and again in those cases where the electronic digital assistant query services identification function contacted the access camera electronic digital assistant service to further limit and/or filter where the access camera electronic digital assistant service is available relative to the selected sub-portion of the graphical underlay, the access camera electronic digital assistant service may store a copy of the selected sub-portion of the graphical underlay, or metadata associated therewith, and the resultant particular video cameras or locations of the video cameras indicated by circular symbols 424 that were provided back to the electronic digital assistant query services identification function, so that when the electronic computing device again provides the selected sub-portion of the graphical underlay to it in response to activation of the “Camera Feed” actionable user interface element 425, the access camera electronic digital assistant service may match the selected sub-portion of the graphical underlay, or metadata associated therewith, provided by the electronic computing device with the previously stored selected sub-portion of the graphical underlay, or metadata associated therewith, and immediately identify the resultant particular video cameras (or locations thereof) indicated by circular symbols 424 stored as linked to the selected sub-portion of the graphical underlay, or metadata associated therewith. Other possibilities exist as well.

As another example, user activation of the displayed “Assign Roadblock” actionable user interface element 423 may cause the electronic computing device to contact the roadblock placement electronic digital assistant service associated with the element 423, perhaps via the path to the service provided to the electronic computing device by the electronic digital assistant query services identification function at step 308 (or stored locally at the electronic computing device as a service identity to path mapping and identified by referencing the mapping at the electronic computing device using the identity of the electronic digital assistant service associated with the “Assign Roadblock” actionable user interface element 423 and provided by the electronic digital assistant query services identification function) and receive, in response, an indication that roadblocks were placed (e.g., electro-mechanically if embedded in streets) or were dispatched to be placed (e.g., via a dispatch to a traffic control officer with roadblock equipment) and the electronic computing device, in response to receiving confirmation of placement or dispatch, may display the output as visual roadblock icons placed on the streets and/or intersections of the selected sub-portion of the graphical underlay within oval 422.

The roadblock placement electronic digital assistant service may identify the locations at which to place (or dispatch to place) roadblocks within oval 420 in any number of different ways. In one embodiment, the electronic computing device may provide the selected sub-portion of the graphical underlay, or metadata associated therewith, to the roadblock placement electronic digital assistant service in a same or similar manner as set forth above with respect to the electronic digital assistant query services identification function, and the roadblock placement electronic digital assistant service may process the selected sub-portion of the graphical underlay in much the same way as the electronic digital assistant query services identification function.

Alternatively, and in those cases where the electronic digital assistant query services identification function contacted the roadblock placement electronic digital assistant service to further identify, limit, and/or filter where the roadblock placement electronic digital assistant service is available relative to the selected sub-portion of the graphical underlay, the electronic digital assistant query services identification function may provide one or more unique identifiers (that, e.g., identify the roadblocks themselves or locations in the selected sub-portion at which the roadblocks may be placed) associated with the locations at which the roadblocks may be placed or dispatched back to the electronic computing device for further transmission back to the roadblock placement electronic digital assistant service upon activation of the “Assign Roadblock” actionable user interface element 423 so that the roadblock placement electronic digital assistant service does not need to re-process the selected sub-portion of the graphical underlay, or metadata associated therewith, to identify the roadblocks themselves or particular locations thereof. In a still further embodiment, and again in those cases where the electronic digital assistant query services identification function contacted the roadblock placement electronic digital assistant service to further identify, limit, and/or filter where the access roadblock placement and/or dispatch locations are available relative to the selected sub-portion of the graphical underlay, the roadblock placement electronic digital assistant service may store a copy of the selected sub-portion of the graphical underlay, or metadata associated therewith, and of the resultant locations provided back to the electronic digital assistant query services identification function (and/or the identities of the roadblocks themselves), so that when the electronic computing device again provides the selected sub-portion of the graphical underlay to it in response to activation of the “Assign Roadblock” actionable user interface element 423, the roadblock placement electronic digital assistant service may match the selected sub-portion of the graphical underlay, or metadata associated therewith, provided by the electronic computing device with the previously stored selected sub-portion of the graphical underlay, or metadata associated therewith, and immediately identify the resultant locations for roadblocks or roadblocks themselves stored as linked to the selected sub-portion of the graphical underlay, or metadata associated therewith. Other possibilities exist as well.

As a still other example, user activation of the displayed “License Plate Lookup” actionable user interface element 443 may cause the electronic computing device to contact the license plate lookup electronic digital assistant service associated with the element 443, perhaps via the path to the service provided to the electronic computing device by the electronic digital assistant query services identification function at step 308 (or stored locally at the electronic computing device as a service identity to path mapping and identified by referencing the mapping at the electronic computing device using the identity of the electronic digital assistant service associated with the “License Plate Lookup” actionable user interface element 443 and provided by the electronic digital assistant query services identification function) and receive, in response, an indication of registered owner information (e.g., a person or company name registered as owner of the vehicle associated with the license plate, vehicular make and/or model information associated with the license plate, perhaps in addition to other information, such as outstanding warrants or tickets, current insurance information, etc.), and the electronic computing device, in response to receiving the registered owner information, may display the output as visual text placed on, over, or adjacent the vehicle and/or plates of the selected sub-portion of the graphical underlay within circle 440.

The license plate lookup electronic digital assistant service may identify the license plate information on which to operate within circle 440 in any number of different ways. In one embodiment, the electronic computing device may provide the selected sub-portion of the graphical underlay, or metadata associated therewith, to the license plate lookup electronic digital assistant service in a same or similar manner as set forth above with respect to the electronic digital assistant query services identification function, and the license plate lookup electronic digital assistant service may process the selected sub-portion of the graphical underlay in much the same way as the electronic digital assistant query services identification function.

Alternatively, and in those cases where the electronic digital assistant query services identification function contacted the license plate lookup electronic digital assistant service to further identify, limit, and/or filter where the license plate lookup electronic digital assistant service is available relative to the selected sub-portion of the graphical underlay, the electronic digital assistant query services identification function may provide one or more unique identifiers (that, e.g., identify the license plates themselves or locations in the selected sub-portion at which the license plates appear) associated with the license plates identified in the selected sub-portion of the graphical underlay or a sub-selection of those license plates identified in the selected sub-portion of the graphical underlay that may be associated with registered owners having some connection to a current incident or other context, back to the electronic computing device for further transmission back to the license plate lookup electronic digital assistant service upon activation of the “License Plate Lookup” actionable user interface element 443 so that the license plate lookup electronic digital assistant service does not need to re-process the selected sub-portion of the graphical underlay, or metadata associated therewith, to identify the particular license plate(s) or locations thereof In a still further embodiment, and again in those cases where the electronic digital assistant query services identification function contacted the license plate lookup electronic digital assistant service to help identify or further limit and/or filter where the license plate locations are available relative to the selected sub-portion of the graphical underlay, the license plate lookup electronic digital assistant service may store a copy of the selected sub-portion of the graphical underlay, or metadata associated therewith, and of the resultant locations provided back to the electronic digital assistant query services identification function (and/or the license plates contents itself), so that when the electronic computing device again provides the selected sub-portion of the graphical underlay to it in response to activation of the “License Plate Lookup” actionable user interface element 443, the license plate lookup electronic digital assistant service may match the selected sub-portion of the graphical underlay, or metadata associated therewith, provided by the electronic computing device with the previously stored selected sub-portion of the graphical underlay, or metadata associated therewith, and immediately identify the resultant locations (and/or license plates themselves) of license plates stored as linked to the selected sub-portion of the graphical underlay, or metadata associated therewith. Other possibilities exist as well.

As one further example, user activation of the displayed “Contact Business” actionable user interface element 445 may cause the electronic computing device to contact the contact information lookup electronic digital assistant service associated with the element 445, perhaps via the path to the service provided to the electronic computing device by the electronic digital assistant query services identification function at step 308 (or stored locally at the electronic computing device as a service identity to path mapping and identified by referencing the mapping at the electronic computing device using the identity of the electronic digital assistant service associated with the “Contact Business” actionable user interface element 445 and provided by the electronic digital assistant query services identification function) and receive, in response, an indication of a registered owner information (e.g., a person's name registered as owner of the business identified by the business sign, type of business information associated with the business sign, perhaps in addition to other information, such as outstanding taxes, current permit or licensing information, etc.) and the electronic computing device, in response to receiving the registered owner information, may display the output as visual text placed on, over, or adjacent the business sign of the selected sub-portion of the graphical underlay within circle 440.

The contact information lookup electronic digital assistant service may identify the business sign on which to operate within circle 440 in any number of different ways. In one embodiment, the electronic computing device may provide the selected sub-portion of the graphical underlay, or metadata associated therewith, to the contact information lookup electronic digital assistant service in a same or similar manner as set forth above with respect to the electronic digital assistant query services identification function, and the contact information lookup electronic digital assistant service may process the selected sub-portion of the graphical underlay in much the same way as the electronic digital assistant query services identification function.

Alternatively, and in those cases where the electronic digital assistant query services identification function contacted the contact information lookup electronic digital assistant service to further identify, limit, and/or filter where the contact information lookup electronic digital assistant service is available relative to the selected sub-portion of the graphical underlay, the electronic digital assistant query services identification function may provide one or more unique identifiers (that, e.g., identify the business signs themselves or locations in the selected sub-portion at which the business signs appear) associated with the business signs identified in the selected sub-portion of the graphical underlay or a sub-selection of those business signs identified in the selected sub-portion of the graphical underlay that may be associated with registered owners having some connection to a current incident or other context, back to the electronic computing device for further transmission back to the contact information lookup electronic digital assistant service upon activation of the “Contact Business” actionable user interface element 445 so that the contact information lookup electronic digital assistant service does not need to re-process the selected sub-portion of the graphical underlay, or metadata associated therewith, to identify the particular business sign(s) and/or locations thereof. In a still further embodiment, and again in those cases where the electronic digital assistant query services identification function contacted the contact information lookup electronic digital assistant service to help identify or further limit and/or filter where the business sign locations are available relative to the selected sub-portion of the graphical underlay, the contact information lookup electronic digital assistant service may store a copy of the selected sub-portion of the graphical underlay, or metadata associated therewith, and of the resultant locations provided back to the electronic digital assistant query services identification function (and/or the business sign text itself), so that when the electronic computing device again provides the selected sub-portion of the graphical underlay to it in response to activation of the “Contact Business” actionable user interface element 445, the contact information lookup electronic digital assistant service may match the selected sub-portion of the graphical underlay, or metadata associated therewith, provided by the electronic computing device with the previously stored selected sub-portion of the graphical underlay, or metadata associated therewith, and immediately identify the resultant locations (and/or business sign text itself) of business signs stored as linked to the selected sub-portion of the graphical underlay, or metadata associated therewith. Other possibilities exist as well.

As a final example, user activation of the displayed “Facial Recognition” actionable user interface element 453 may cause the electronic computing device to contact the facial recognition electronic digital assistant service associated with the element 453, perhaps via the path to the service provided to the electronic computing device by the electronic digital assistant query services identification function at step 308 (or stored locally at the electronic computing device as a service identity to path mapping and identified by referencing the mapping at the electronic computing device using the identity of the electronic digital assistant service associated with the “Facial Recognition” actionable user interface element 453 and provided by the electronic digital assistant query services identification function) and receive, in response, an indication of personally identifiable information associated with the user whose face is recognized (e.g., a person's name, hair color, height, weight, home address, hometown, registered vehicles, outstanding warrants, occupations, licenses, etc.) and the electronic computing device, in response to receiving the personally identifiable information, may display the output as visual text placed on, over, or adjacent the person whose face was recognized of the selected sub-portion of the graphical underlay within circle 450.

The facial recognition lookup electronic digital assistant service may identify the face on which to operate within circle 450 in any number of different ways. In one embodiment, the electronic computing device may provide the selected sub-portion of the graphical underlay, or metadata associated therewith, to the facial recognition electronic digital assistant service in a same or similar manner as set forth above with respect to the electronic digital assistant query services identification function, and the facial recognition electronic digital assistant service may process the selected sub-portion of the graphical underlay in much the same way as the electronic digital assistant query services identification function.

Alternatively, and in those cases where the electronic digital assistant query services identification function contacted the facial recognition electronic digital assistant service to further identify, limit, and/or filter where the facial recognition electronic digital assistant service is available relative to the selected sub-portion of the graphical underlay, the electronic digital assistant query services identification function may provide one or more unique identifiers (that, e.g., uniquely identify persons associated with the faces or locations in the selected sub-portion at which the faces appear) associated with the faces identified in the selected sub-portion of the graphical underlay or a sub-selection of those faces identified in the selected sub-portion of the graphical underlay that may be associated with persons having some connection to a current incident or other context, back to the electronic computing device for further transmission back to the facial recognition electronic digital assistant service upon activation of the “Facial Recognition” actionable user interface element 453 so that the facial recognition electronic digital assistant service does not need to re-process the selected sub-portion of the graphical underlay, or metadata associated therewith, to identify the particular person(s) or locations of the particular face(s).

In a still further embodiment, and again in those cases where the electronic digital assistant query services identification function contacted the facial recognition electronic digital assistant service to help identify or further limit and/or filter where the faces are available relative to the selected sub-portion of the graphical underlay, the facial recognition electronic digital assistant service may store a copy of the selected sub-portion of the graphical underlay, or metadata associated therewith, and of the resultant locations provided back to the electronic digital assistant query services identification function (and/or the identities of the person(s) associated with the face(s)), so that when the electronic computing device again provides the selected sub-portion of the graphical underlay to it in response to activation of the “Facial Recognition” actionable user interface element 453, the facial recognition electronic digital assistant service may match the selected sub-portion of the graphical underlay, or metadata associated therewith, provided by the electronic computing device with the previously stored selected sub-portion of the graphical underlay, or metadata associated therewith, and immediately identify the resultant locations of (and/or the identities of) faces stored as linked to the selected sub-portion of the graphical underlay, or metadata associated therewith. Other possibilities exist as well.

In some embodiments, and after a passage of a predetermined period of time such as 20, 40, or 60s, or after a detection of a user selection of some other displayed actionable user interface element other than the one or more displayed at step 310 or some other event, the one or more actionable user interface elements displayed at step 310 (and their associated line 421 or oval 422, 442, 444, 452 sub-portion indicators) may be removed from the display element. In some embodiments, and prior to removal, the one or more actionable user interface elements displayed at step 310 (and their associated line 421 or oval 422, 442, 444, 452 sub-portion indicators) may be saved in a local storage such that future user gestures encompassing same or overlapping selected sub-portions of the graphical underlay may be immediately retrieved from storage and displayed, while in other embodiments, the process set forth above may be required to be executed to ensure that such services are still available. Other possibilities exist as well.

Furthermore, each electronic digital assistant service returned to the electronic computing device by the electronic digital assistant query services identification function may be assigned an associated priority level (e.g., low, medium, or high, or some other value such as 1, 5, or 10 where 1 is the lowest priority and 10 the highest priority), such that actionable user interface elements associated with electronic digital assistant services having higher assigned priorities are displayed at the display element more prominently (e.g., with a higher font, a higher size, a bolder color, a different shape, a particular order from highest priority to lowest priority or vice versa, or via some other manner) than actionable user interface elements associated with electronic digital assistant services having lower assigned priorities. The priority levels assigned to each electronic digital assistant service may be stored at a service priority mapping stored at the electronic computing device, or may be stored at the electronic digital assistant query services identification function and returned to the electronic computing device at step 308 accompanying the identification of the available services. For example, and with reference to FIG. 4, the “Camera Feed” actionable user interface element 425 associated with the access camera electronic digital assistant service may be assigned a higher priority than the “Assign Roadblock” actionable user interface element 423 associated with the assign roadblock electronic digital assistant service, and thus may be displayed at a higher priority left-based ordered position, or in other embodiments not illustrated in FIG. 4, displayed having a larger font or border size, among other possibilities.

As one further example, and assuming that such priority information set forth above is received or already stored locally, and after the passage of the predetermined period of time such as 20, 40, or 60s, instead of removing the one or more actionable user interface elements displayed at step 310 (and their associated line 421 or oval 422, 442, 444, 452 sub-portion indicators) from the display element, one or more of the highest priorities, or only the highest priority, electronic digital assistant services associated with the displayed actionable user interface elements may be automatically executed, and the output displayed at the display element consistent with the foregoing description. Other possibilities exist as well.

3. Conclusion

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method at an electronic computing device for providing an adaptable interface for retrieving available electronic digital assistant services, the method comprising:
displaying, by the electronic computing device via a display element communicatively coupled to the electronic computing device, a user interface including a graphical underlay on which user input gestures may be operated;
detecting, by the electronic computing device via an input mechanism by which user input gestures may be detected, a particular user input gesture selecting a sub-portion of the graphical underlay;
providing, by the electronic computing device, the selected sub-portion of the graphical underlay or metadata associated therewith, to an electronic digital assistant services query identification function;
receiving, at the electronic computing device from the electronic digital assistant services query identification function, identities of one or more available electronic digital assistant services that may be performed on objects or information included in the selected sub-portion of the graphical underlay or metadata associated therewith; and
displaying, by the electronic computing device via the display element, one or more actionable user interface elements on, over, or adjacent to the graphical underlay corresponding to the received identities of the one or more available electronic digital assistant services.

2. The method of claim 1, further comprising:
detecting, via the input mechanism, a user actuation of a particular one of the one or more actionable user interface elements and responsively causing an electronic digital assistant function associated with the particular one of the one or more actionable user interface elements to be performed on the selected sub-portion of the graphical underlay or metadata associated therewith.

3. The method of claim 2, further comprising receiving an output from the electronic digital assistant function associated with the particular one of the one or more actionable user interface elements and displaying by the electronic computing device via a display element, on, over, adjacent to, or in place of the graphical underlay, the output.

4. The method of claim 3, wherein the selected sub-portion of the graphical underlay or metadata associated therewith includes a graphical image capture of a human face, the particular one of the one or more actionable user interface elements is associated with a facial recognition electronic digital assistant function, and the output includes a name or other personal information associated with the human face.

5. The method of claim 3, wherein the selected sub-portion of the graphical underlay or metadata associated therewith includes a cartographic feature, the particular one of the one or more actionable user interface elements is associated with dispatch of a cartographic function associated with the cartographic feature, and the output includes a graphical icon associated with the cartographic function.

6. The method of claim 5, wherein the cartographic feature is one of an intersection and street address, and the cartographic function one of a dispatch of a first responder and assignment of a road block.

7. The method of claim 3, wherein the selected sub-portion of the graphical underlay or metadata associated therewith includes a graphical image capture of alphanumeric text, the particular one of the one or more actionable user interface elements is associated with a license plate lookup electronic digital assistant function, and the output includes one or both of (i) a name or other personal information associated with a determined owner of a vehicle associated with the alphanumeric text and (ii) make and/or model information of the vehicle associated with the alphanumeric text.

8. The method of claim 1, further comprising receiving, from the electronic digital assistant services query identification function, identified further sub-portions of the selected sub-portion of the graphical underlay, each identified further sub-portion being associated with a particular one of the identities of one or more available electronic digital assistant services that may be performed and that are linked to the further sub-portion of the selected sub-portion, and the electronic computing device responsively displaying respective further sub-portion indicators on the graphical overlay of the identified further sub-portions.

9. The method of claim 8, further comprising receiving identities of two or more available electronic digital assistant services that may be performed, and wherein the electronic computing device displaying respective further sub-portion indicators on the graphical overlay of the identified further sub-portions comprises displaying each respective further sub-portion indicator having a particular and unique color, pattern, or shape.

10. The method of claim 8, wherein the step of displaying the one or more actionable user interface elements on, over, or adjacent to the graphical underlay corresponding to the received identities of the one or more available electronic digital assistant services comprises displaying two or more actionable user interface elements on, over, or adjacent to the graphical underlay corresponding to the received identities of the two or more available electronic digital assistant services, and further wherein each of the two or more actionable user interface elements is displayed including a same particular and unique color, pattern, or shape as the further sub-portion indicator with which it is associated.

11. The method of claim 1, wherein the electronic digital assistant services query identification function is provided by the electronic computing device.

12. The method of claim 1, wherein the electronic digital assistant services query identification function is provided by a remote computing device, and wherein providing the selected sub-portion of the graphical underlay or metadata associated therewith to the electronic digital assistant services query identification function comprises transmitting the selected sub-portion of the graphical underlay or metadata associated therewith to the remote computing device via one or both of a wired and a wireless communications network and wherein receiving, from the electronic digital assistant services query identification function, identities of one or more available electronic digital assistant services comprises receiving the identities of one or more available electronic digital assistant services via the one or both of the wired and wireless communications network.

13. The method of claim 1, wherein the electronic computing device is one of a portable computing device worn on a body of the user, a vehicular mobile computing device integrated in a vehicle that the user is operating, and a laptop or tablet computing device held by the user.

14. The method of claim 1, wherein the graphical underlay is part of a whiteboarding application, the method further comprising prior to detecting, by the electronic computing device via the input mechanism, the particular user input gesture selecting the sub-portion of the graphical underlay:
detecting, via the input mechanism, a user selection of an electronic digital assistant query tool from a plurality of available whiteboarding tools displayed in the user interface and detecting, while the electronic digital assistant query tool is selected, the particular user input gesture selecting a sub-portion of the graphical underlay.

15. The method of claim 1, further comprising removing, by the electronic computing device via the display element, the one or more actionable user interface elements in response to one of a passage of a predetermined period of time and a detected user selection of one of the one or more actionable user interface elements.

16. The method of claim 1, further comprising:
receiving, at the electronic computing device from the electronic digital assistant services query identification function, identities of two or more available electronic digital assistant services and displaying two or more actionable user interface elements on, over, or adjacent to the graphical underlay corresponding to the received identities of the one or more available electronic digital assistant services;
receiving priorities associated with each of the identities of the two or more available electronic digital assistant services; and
displaying the two or more actionable user interface elements corresponding to the received identities of the two or more available electronic digital assistant services in a prioritized order from a highest priority to a lowest priority as a function of the received priorities.

17. The method of claim 1, wherein the electronic digital assistant services query identification function is a public safety electronic digital assistant services query identification function and the identities of one or more available electronic digital assistant services are public safety related services.

18. The method of claim 1, wherein the one or more actionable user interface elements are provided by the electronic digital assistant services query identification function accompanying or transmitted separately from, the identities of one or more available electronic digital assistant services.

19. The method of claim 1, wherein detecting the particular user input gesture selecting the sub-portion of the graphical underlay comprises detecting one of (i) a user input drawing a bounded geometric figure where the sub-portion is defined by the bounds of the geometric figure and (ii) a user input drawing a line that does not form a bounded geometric figure where the sub-portion is defined by the line plus a predefined additional area adjacent the line.

20. An electronic computing device implementing an adaptable interface for retrieving available electronic digital assistant services, the electronic computing device comprising:
a memory storing non-transitory computer-readable instructions;
a transceiver;
a display element;
an input mechanism by which user input gestures may be detected; and
one or more processors configured to, in response to executing the non-transitory computer-readable instructions, perform a first set of functions comprising:
display, via the display element, a user interface including a graphical underlay on which user input gestures may be operated;
detect, via the input mechanism, a particular user input gesture selecting a sub-portion of the graphical underlay;
provide the selected sub-portion of the graphical underlay or metadata associated therewith to an electronic digital assistant services query identification function;
receive, from the electronic digital assistant services query identification function, identities of one or more available electronic digital assistant services that may be performed on objects or information included in the selected sub-portion of the graphical underlay or metadata associated therewith; and
display, via the display element, one or more actionable user interface elements on, over, or adjacent to the graphical underlay corresponding to the received identities of the one or more available electronic digital assistant services.
